(19) United States
(12) Patent Application Publication
(10) Pub. No.: US 2022/0206497 A1
(43) Pub. Date: Jun. 30, 2022

(54) VEHICLE DRIVING GUIDANCE SYSTEM AND OPERATION METHOD THEREOF

(71) Applicant: HYUNDAI MOBIS Co., LTD., Seoul (KR)

(72) Inventors: Douglas C. Mackenzie, Livonia, MI (US); Senthil Kumar Seetharaman, Plymouth, MI (US)

(21) Appl. No.: 17/133,904

(22) Filed: Dec. 24, 2020

(51) Int. Cl. G05D 1/02; G01C 21/36

(52) U.S. Cl. CPC G05D 1/0212; G01C 21/3605; G01C 21/3667; G01C 21/3629; G01C 21/3608

(57) ABSTRACT

A vehicle driving guidance system and an operation method thereof includes a data provider configured to store map data therein or to receive map data from outside, a user interface configured to receive information on a destination from a user or to guide the user to a path, and a path generator configured to generate a driving path of the vehicle to the received destination in consideration of an autonomous driving level of the vehicle and autonomous driving permission information for each driving road included in the map data.

### BACKGROUND

### Field

Exemplary embodiments relate to a vehicle driving guidance system and an operation method thereof for storing map data and generating driving paths depending on an autonomous driving level of a vehicle in consideration of the autonomous driving level of the vehicle and autonomous driving permission information for each driving path included in the map data.

### Discussion of the Background

In accordance with recent trends, as technology of autonomous driving of vehicles has been rapidly developed, it is necessary to set an autonomous driving path depending on an autonomous driving level of a vehicle, a traffic situation, and the like while an autonomous vehicle travels. The society of automotive engineers (SAE) defines a total of is six autonomous driving levels from level 0 without autonomous driving to level 5 with complete autonomous driving, and a path on which a vehicle travels through an autonomous driving function at a corresponding level may be different for each level.

For example, on an expressway in which an environment around a vehicle required for autonomous driving is very easily sensed and a boundary between roads or lanes is clear, the vehicle is conveniently driven through an autonomous driving function at a high level, but on a road in which an environment around a vehicle is not easily sensed and a boundary between roads or lanes is unclear, such as on a busy road or an unpaved road, a driver needs to inevitably intervene in driving and to use an autonomous driving function at a low level.

Accordingly, there is a need to develop a vehicle driving guidance system that is flexibly configured and optimized for autonomous driving so as to generate a driving path in consideration of each traffic situation and an autonomous driving level of a vehicle and to allow a user to select a driving path depending on a situation.

The contents described as the related art have been provided only to assist in understanding the background of the inventive concepts and should not be considered as corresponding to the related art known to those having ordinary skill in the art.

### SUMMARY

Exemplary embodiments of the inventive concepts provide a vehicle driving guidance system and an operation method thereof to store map data, generate a driving path depending on an autonomous driving level of a vehicle in consideration of the autonomous is driving level of the vehicle and autonomous driving permission information for each driving path included in the map data, guiding the user to the generated driving path, and permitting the vehicle to reach a destination along the driving path through an autonomous driving function.

Additional features of the invention will be set forth in the description which follows, and in part will be apparent from the description, or may be learned by practice of the invention.

According to an embodiment of the inventive concepts, a vehicle driving guidance system includes a data provider configured to store map data therein or to receive map data from outside, a user interface configured to receive information on a destination from a user or to guide the user to a path, and a path generator configured to generate a driving path of the vehicle to the received destination in consideration of an autonomous driving level of the vehicle and autonomous driving permission information for each driving road included in the map data.

The autonomous driving permission information for each driving road may include information on a road or a section in which autonomous driving is permitted for each autonomous driving level of the vehicle.

The path generator may generate a plurality of driving paths including shortest path or a fastest path to the received destination or a path on which autonomous driving at a highest autonomous driving level is permitted.

The user interface may guide the user to the plurality of driving paths generated by the path generator and may guide the user to select a preferred driving path from among the plurality of driving paths.

The user interface may receive information on a destination from the user or may guide the user to a path using a method including a display, voice, or a mobile device of the user.

The path generator may re-generate the driving path of the vehicle based on a changed destination or path when the user requests destination or path change while the vehicle travels.

The path generator may update the driving path depending on a state of the vehicle, a state of the user, or a situation of the driving path while the vehicle travels.

The vehicle driving guidance system may further include an autonomous driving unit configured to receive the driving path from the path generator and control an autonomous driving function depending on the autonomous driving level of the vehicle to drive the vehicle along the driving path.

The path generator may store a driving path generated for each user, for each destination, or for each time, and the user interface may guide the user to the driving path generated for each user, for each destination, or for each time.

According to another embodiment of the inventive concepts, an operation method of the vehicle driving guidance system includes a collecting operation of storing the map data inside or receiving the map data from the outside, a receiving operation of receiving the destination from the user, a generating operation of generating the driving path of the vehicle to the received destination in consideration of the autonomous driving level of the vehicle and autonomous driving permission information for each driving path included in the map data, and a guiding operation of guiding the user to the driving path generated in the generating operation.

The operation method may further include a driving operation of guiding the user to select the driving path preferred by the user and driving the vehicle along the selected driving path after the guiding operation.

The operation method may further include a re-generating operation of re-generating the driving path of the vehicle based on the changed destination or path when the user requests the destination or path change while the vehicle travels after the driving operation.

The operation method may further include an updating operation of updating the driving path depending on the state of the vehicle, the state of the user, or a situation of the driving path while the vehicle travels after the driving operation.

It is to be understood that both the foregoing general description and the following detailed description are exemplary and explanatory and are intended to provide further explanation of the invention as claimed.

### BRIEF DESCRIPTION OF THE DRAWINGS

The above and other objects, features and other advantages of the inventive concepts will be more clearly understood from the following detailed description taken in conjunction with the accompanying drawings, in which:

FIG. 1 is a diagram illustrating a vehicle driving guidance system according to an embodiment of the inventive concepts; and

FIG. 2 is a flowchart illustrating an operation method of a vehicle driving guidance system according to an embodiment of the inventive concepts.

### DETAILED DESCRIPTION OF THE ILLUSTRATED EMBODIMENTS

The invention is described more fully hereinafter with reference to the accompanying drawings, in which embodiments of the invention are illustrated. This invention may, however, be embodied in many different forms and should not be construed as limited to the embodiments set forth herein. Rather, these embodiments are provided so that this disclosure is thorough, and will fully convey the scope of the invention to those skilled in the art. Like reference numerals in the drawings denote like elements.

Various advantages and features of the present invention and methods accomplishing thereof will become apparent from the following description of embodiments with reference to the accompanying drawings. However, the present invention is not be limited to the embodiments set forth herein but may be implemented in many different forms. The present embodiments may be provided so that the disclosure of the present invention will be complete, and will fully convey the scope of the invention to those skilled in the art and therefore the present invention will be defined within the scope of claims. Like reference numerals throughout the description denote like elements.

Unless defined otherwise, it is to be understood that all the terms (including technical and scientific terms) used in the specification has the same meaning as those that are understood by those who skilled in the art. Further, the terms defined by the dictionary generally used should not be ideally or excessively formally defined unless clearly defined specifically. It will be understood that for purposes of this disclosure, “at least one of X, Y, and Z” can be construed as X only, Y only, Z only, or any combination of two or more items X, Y, and Z (e.g., XYZ, XYY, YZ, ZZ). Unless particularly described to the contrary, the term “comprise”, “configure”, “have”, or the like, which are described herein, will be understood to imply the inclusion of the stated components, and therefore should be construed as including other components, and not the exclusion of any other elements.

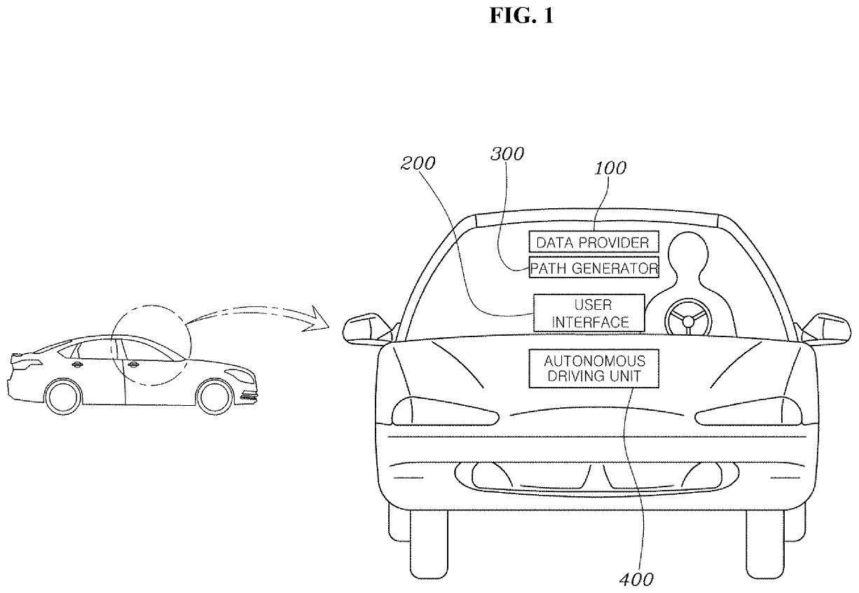

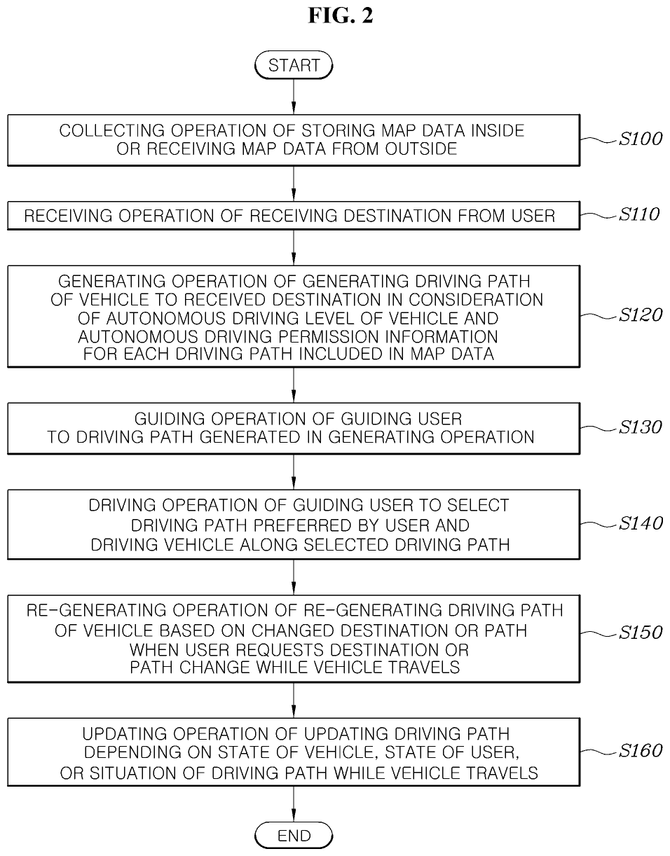

FIG. 1 is a diagram illustrating a vehicle driving guidance system according to an embodiment of the inventive concepts. FIG. 2 is a flowchart illustrating an operation method of a vehicle driving guidance system according to an embodiment of the inventive concepts.

As illustrated in FIG. 1, a vehicle driving guidance system according to an embodiment of the inventive concepts may include a data provider 100 configured to store map data therein or receive map data from the outside, a user interface 200 configured to receive information on a destination from a user or guiding the user to a path, and a path generator 300 configured to generate a driving path of the vehicle to the received destination in consideration of an autonomous driving level of the vehicle and autonomous driving permission information for each driving road included in the map data. The data provider 100 may receive pre-loaded data prior to interacting with outside entities. Map data received from the outside may be stored in the data provider 100. An autonomous driving unit 400 may store the autonomous driving level of the vehicle and autonomous driving permission information for each driving road included in the map data.

The data provider 100, the user interface 200, the path generator 300, or the autonomous driving unit 400 according to an embodiment of the inventive concepts may be embodied through a non-volatile memory (not illustrated) configured to store an algorithm configured to control operations of various components of the vehicle or data about a software command configured to reproduce the algorithm, and a processor configured to perform an operation to be described below using data stored in a corresponding memory. Here, the memory and the processor may be embodied as respective chips. Alternatively, the memory and the processor may be a single integrated chip. The processor may be configured as one or more processors.

In detail, the autonomous driving level of the vehicle may include six levels including a level 0 at which a driver directly drives the vehicle, a level 1 at which the driver drives the vehicle and a system aids in acceleration/deceleration or steering of the vehicle, a level 2 at which the driver drives the vehicle and the system aids in acceleration/deceleration and steering of the vehicle, a level 3 at which the system drives the vehicle and the driver drives the vehicle immediately when there is a request of the system, a level 4 at which the system drives the vehicle and the driver does not intervene in driving in a specific situation, and a level 5 at which the system drives the vehicle in all situations. As the autonomous driving level is increased, higher performance may be desired, and an environment around the vehicle may be more accurately sensed for autonomous driving.

A traffic situation also affects the autonomous driving level of the vehicle, and thus, on a road that has a predetermined standard and in which lanes are clear and a road is appropriately managed like in an expressway, autonomous driving at an autonomous driving level of a high level is possible due to accurate sensing information for autonomous driving, but when lanes are not clear, there are many obstacles around the vehicle, and a road is not appropriately managed like in a narrow road, an unpaved road, or a busy road, it is difficult to sense information for autonomous driving, and very serious noise is also contained in the sensing result.

As such, an autonomous driving permission road section for each autonomous driving level may be defined depending on the accuracy of sensing information for autonomous driving, an operational design domain (ODD) section (a section in which an autonomous driving system is permitted to perform complete autonomous driving) may be a section in which autonomous driving at a high level, that is, complete autonomous driving is possible, and in this section, the vehicle may be capable of performing autonomous driving through an autonomous driving function without intervention of the driver. Thus, the vehicle driving guidance system according to an embodiment of the inventive concepts may differently generate an autonomous driving path depending on a corresponding autonomous driving level for each autonomous driving level of the vehicle according to a destination and may guide the user.

In the vehicle driving guidance system according to an embodiment of the inventive concepts, autonomous driving permission information for each driving path may include information on a road or a section in which autonomous driving is permitted for each autonomous driving level of the vehicle. In other words, the autonomous driving permission information may be information on a path configured to perform autonomous driving using an autonomous driving function depending on a corresponding autonomous driving level for each autonomous driving level of the vehicle. The path generator 300 may generate a simple path to a destination like a navigation device in the case of the autonomous driving level 0 at which the driver directly drives the vehicle, but may generate a path along which the vehicle is capable of reaching the destination through an autonomous driving function depending on a corresponding level in the case of a high autonomous driving level equal to or greater than level 4.

In the vehicle driving guidance system according to an embodiment of the inventive concepts, the path generator 300 may generate a plurality of driving paths including the shortest path or the fastest path to reach a received destination or a path on which autonomous driving at the highest autonomous driving level is permitted. The different paths may be generated separately at different times, or in combination at substantially the same time.

In detail, when generating a driving path of the vehicle, the path generator 300 may generate a plurality of driving paths based on prioritized purposes. First, even if it is cumbersome to drive a vehicle by a user without considering an autonomous driving level, the path generator 300 may generate a driving path for most rapidly reaching the destination, may generate the shortest driving path to the destination, or may also generate a driving path for free passage (no tolls) to the destination. The path generator 300 may generate all of these paths substantially at the same time to allow a user to select a favored option.

On the other hand, when a higher priority is given to a driving path configured to drive at a high autonomous driving level, an autonomous driving function of a vehicle may be maximized even if a user of the vehicle drives the vehicle on a slow path or a long path instead of a rapid path or a short path, and accordingly, driving fatigue may be reduced or the vehicle may reach the destination more conveniently by minimizing a degree by which a user intervenes in driving.

In the vehicle driving guidance system according to an embodiment of the inventive concepts, the user interface 200 may guide the user to one or the plurality of driving paths generated by the path generator 300 and may guide the user to select a preferred driving path from among the plurality of driving paths. The user interface 200 may receive information on a destination from the user or may guide the user to a path using a method including a display, voice, or a mobile device of the user.

In detail, the user interface 200 may guide the user to the plurality of driving paths based on differently prioritized purposes to allow the user to select a driving path having a preferred priority, and may guide the user using a visual or audible method such as a display or voice, and the user may select a preferred driving path through a touchscreen, voice, or an application of a mobile device.

The vehicle driving guidance system according to an embodiment of the inventive concepts may further include the autonomous driving unit 400 configured to receive a driving path from the path generator 300 and controlling an autonomous driving function depending on an autonomous driving level of the vehicle to drive the vehicle along a driving path. The autonomous driving unit 400 may receive the driving path selected by the user from among the plurality of driving paths generated by the path generator 300 and may control an autonomous driving function depending on an autonomous driving level of the vehicle to drive the vehicle along the selected driving path. Autonomous driving levels may be stored in the autonomous driving unit 400 of the vehicle or may be accessed from an external data source.

In the vehicle driving guidance system according to an embodiment of the inventive concepts, when the user requests destination or path change while the vehicle travels, the path generator 300 may generate a driving path of the vehicle according to the changed destination or path. After the user selects one from among the plurality of driving paths generated by the path generator 300, when the vehicle passes by a stop or travels towards a new destination while travelling, the path generator 300 may re-generate the driving path, and the vehicle may reach the changed destination through the changed path.

The path generator 300 may update the driving path depending on the state of the vehicle, the state of the user, or a situation of the driving path while the vehicle travels. The path generator 300 may generate a new driving path to change the path or the destination when a problem occurs in the vehicle or the user while the vehicle travels. For example, the path generator 300 may change the destination to a repair shop or a gas station to generate a new driving path when a problem occurs inside the vehicle or fuel is insufficient, the path generator 300 may change the destination to a hospital to generate a new driving path when the user is injured or does not feel well, and the path generator 300 may also re-generate a driving path because of external factors such as accidents or traffic congestion on the driving path or a poor weather situation.

In the vehicle driving guidance system according to an embodiment of the inventive concepts, the path generator 300 may store a driving path generated for each user, for each destination, or for each time, and the user interface 200 may guide the user to the driving path generated for each user, for each destination, or for each time. In other words, the path generator 300 may store a driving path selected for each user and recommend a preferred driving path for each user or a driving path selected for the same destination or the same time range to the user through the user interface 200 to allow the user to easily and quickly select the driving path.

FIG. 2 is a flowchart illustrating an operation method of a vehicle driving guidance system according to an embodiment of the inventive concepts. The operation method of the vehicle driving guidance system according to an embodiment of the inventive concepts may include a collecting operation S100 of storing map data inside or receiving map data from the outside, a receiving operation S110 of receiving a destination from a user, a generating operation S120 of generating a driving path of the vehicle to the received destination in consideration of an autonomous driving level of the vehicle and autonomous driving permission information for each driving path included in the map data, and a guiding operation S130 of guiding the user to the driving path generated in the generating operation S120, as an operation method of a vehicle driving guidance system.

The operation method of the vehicle driving guidance system according to an embodiment of the inventive concepts may further include a driving operation S140 of guiding the user to select a driving path preferred by the user and driving the vehicle along the selected driving path after the guiding operation S130.

The operation method of the vehicle driving guidance system according to an embodiment of the inventive concepts may further include a re-generating operation S150 of re-generating a driving path of the vehicle based on the changed destination or path when the user requests destination or path change while the vehicle travels after the driving operation S140.

The operation method of the vehicle driving guidance system according to an embodiment of the inventive concepts may further include an updating operation S160 of updating the driving path depending on the state of the vehicle, the state of the user, or a situation of the driving path while the vehicle travels after the driving operation S140.

The vehicle driving guidance system and the operation method thereof according to the inventive concepts may store map data, may generate a driving path depending on an autonomous driving level of a vehicle in consideration of the autonomous driving level of the vehicle and autonomous driving permission information for each driving path included in the map data, may guide the user to the generated driving path, and may permit the vehicle to reach a destination along the driving path through an autonomous driving function.

Although the inventive concepts has been illustrated and described with respect to specific embodiments, it will be apparent to those having ordinary skill in the art that the inventive concepts may be variously modified and altered without departing from the spirit and scope of the inventive concepts as defined by the following claims. In addition, such modifications should also be understood to fall within the scope and spirit of the inventive concepts.

What is claimed is:

1. A vehicle driving guidance system comprising:
a data provider configured to store pre-loaded map data therein or to receive map data from outside and store the outside map data;
a user interface configured to receive information about a destination from a user and to guide the user to a path;
an autonomous driving unit configured to store autonomous driving levels of the vehicle and autonomous driving permission information for each driving road included in the map data; and
a path generator configured to generate a driving path of the vehicle to the received destination in consideration of the autonomous driving level of the vehicle and the ii autonomous driving permission information for each driving road included in the map data.

2. The vehicle driving guidance system of claim 1, wherein the autonomous driving permission information for each driving road comprises:
information on a road; and
a section in which autonomous driving is permitted for each autonomous driving level of the vehicle.

3. The vehicle driving guidance system of claim 1, wherein the path generator generates a plurality of driving paths comprising:
a shortest path;
a fastest path to the received destination; and
a path on which autonomous driving at a highest autonomous driving level is permitted.

4. The vehicle driving guidance system of claim 3, wherein the user interface displays to and guides the user to the plurality of driving paths generated by the path generator and guides the user to select a preferred driving path from among the plurality of driving paths.

5. The vehicle driving guidance system of claim 1, wherein the user interface receives information on a destination from the user or guides the user to a path using a method comprising a display, voice, or a mobile device of the user.

6. The vehicle driving guidance system of claim 1, wherein the path generator re-generates the driving path of the vehicle based on a changed destination or path when the user requests destination or path change while the vehicle travels.

7. The vehicle driving guidance system of claim 1, wherein the path generator updates the driving path depending on a state of the vehicle, a state of the user, or a situation of the driving path while the vehicle travels.

8. The vehicle driving guidance system of claim 1, wherein the autonomous driving unit is further configured to receive the driving path from the path generator and control an autonomous driving function depending on the autonomous driving level of the vehicle to drive the vehicle along the driving path.

9. The vehicle driving guidance system of claim 1, wherein the path generator stores a driving path generated for each user, for each destination, or for each time, and the user interface guides the user to the driving path generated for each user, for each destination, or for each time.

10. A method of operating a vehicle driving guidance system including a data provider, a user interface, and data generator, the method comprising:
a collecting operation of storing pre-loaded map data inside the data generator or receiving the map data from the outside and storing the outside map data in the data generator;
a receiving operation of receiving the destination from the user;
a generating operation of generating a driving path of the vehicle to a received destination in consideration of an autonomous driving level of the vehicle and autonomous driving permission information for each driving path included in the map data; and
a guiding operation of guiding the user to the driving path generated in the generating ii operation.

11. The operation method of claim 10, further comprising:
a driving operation of guiding the user to select the driving path preferred by the user and driving the vehicle along the selected driving path after the guiding operation.

12. The operation method of claim 11, further comprising:
a re-generating operation of re-generating the driving path of the vehicle based on the changed destination or path when the user requests the destination or path change while the vehicle travels after the driving operation.

13. The operation method of claim 11, further comprising:
an updating operation of updating the driving path depending on the state of the vehicle, the state of the user, or a situation of the driving path while the vehicle travels after the driving operation.
